(19) United States
(12) Patent Application Publication
(10) Pub. No.: US 2017/0221237 A1
(43) Pub. Date: Aug. 3, 2017

(54) DATA VISUALIZATION SYSTEM FOR EXPLORING RELATIONAL INFORMATION

(71) Applicants: Angela T. Pate, Gainesville, FL (US); Millard E. Pate, Gainesville, FL (US)

(72) Inventors: Angela T. Pate, Gainesville, FL (US); Millard E. Pate, Gainesville, FL (US)

(21) Appl. No.: 15/012,807

(22) Filed: Feb. 1, 2016

(51) Int. Cl. G06T 11/20; G06T 17/10

(52) U.S. Cl. CPC G06T 11/206; G06T 17/10

(57) ABSTRACT

A system and methods for interactively displaying multi-dimensional data. The data, expressing relational information organized in a plurality of dimensions, can be visually represented by a three-dimensional model having a plurality of concentric rings. The plurality of concentric rings may correspond to the plurality of dimensions. A ring of the plurality of concentric rings may be sized to represent ordering and magnitude of the data values corresponding to a dimension. An image, illustrating a view of the three-dimensional model, may be displayed. User input may specify modifications of the data and may also manipulate the manner in which it is presented, allowing a user to control the visual representation of the data to quickly understand the data and what it represents.

### BACKGROUND

Data may be represented in a variety of formats including graphs, charts, and tables. A format of data representation may be selected by an individual based on the type of data and the type of information extracted from the data. While data having a few dimensions may be represented in a variety of formats, as the number of dimensions increases, formats that may aid in understanding the data may be unavailable.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of an exemplary system for an exemplary data visualization system in accordance with some embodiments;

FIG. 2A is an exemplary data input graphical user interface;

FIG. 2B is an exemplary data visualization graphical user interface;

FIG. 3 is an exemplary visual representation of a three-dimensional model;

FIGS. 4A and 4B are exemplary visual representations of three-dimensional models;

FIGS. 5A and 5B are exemplary visual representations of three-dimensional models;

FIG. 6 is an exemplary visual representation of a three-dimensional model

FIG. 7 is an exemplary visual representation of a zoomed view of a three-dimensional model;

FIG. 8 is an exemplary visual representation of a three-dimensional model having details for a portion of the three-dimensional model;

FIGS. 9A-C are exemplary visual representations depicting the progression of an unwrapped model;

FIGS. 10A-C are exemplary visual representations depicting the progression of a slice view for a three-dimensional model; and

FIG. 11 is a block diagram of an exemplary computer system on which some embodiments may be implemented.

### DETAILED DESCRIPTION

Data visualization may assist a person's understanding and interpretation of data. Conventional visual representation of data, such as graphs, charts, and tables, may have limitations for certain types of data, particularly data having more than two dimensions. The inventors have recognized that representing data in a visual format in which relationships between multiple dimensions are simultaneously visible may enable a person to quickly derive meaning from the data. The user's ability to understand the data and derive meaning from the data may be enhanced by a dynamic representation through which the user can provide inputs that modify the data or the manner in which it is represented.

The inventors have appreciated that visually representing data with multiple dimensions as multiple concentric rings may provide an improved, intuitive visual representation for the data. Such a visual representation may facilitate a person's understanding of the data and enable the person to achieve a better understanding of the interrelationships between data of different dimensions. Further, a system can be configured to accept user inputs that change the data and or the representation of the data, allowing a user to quickly understand the data or how changes in the data impact different dimensions of the data.

In accordance with some embodiments, a visual representation may include a plurality of concentric rings corresponding to a plurality of dimensions. A ring corresponding to a dimension may be sized to represent the magnitude of the data values. The ordering of data values within a ring may be represented based on a position around the ring, and a visual characteristic of the ring, such as its thickness, at each position may represent the value in the order corresponding to that position. For example, in some embodiments, values may be ordered based on time, which may correspond to either clockwise or counterclockwise direction around a ring. A specific value of the data may be represented by a visual characteristic of a ring at a specific position. In some embodiments, that visual characteristic may be thickness of the ring or height of the ring above a nominal reference plane (e.g., a plane common to the concentric rings). In some embodiments, height above the nominal reference plane may indicate a positive number, while height below the nominal reference plane may represent a negative value.

In some embodiments, multiple dimensions of the data may be visually represented by multiple rings that are positioned concentrically. The concentric rings may have the appearance of a wheel. The visual characteristics of the concentric rings at corresponding radial positions may show corresponding values of the different dimensions. The image may be rendered with rings having different colors or other visual characteristics to enable quick differentiation between values associated with the different dimensions.

As a specific example, the financials of a business may be represented as a multi-dimensioned data set. One dimension may represent profit. Other dimensions may represent other values, such as expenses or income. The ordinal of such a data set may be time such that data values positioned around a ring may provide an indication of the haw the data for a dimension changes over time. By presenting data as a function of time as concentric rings, relationships between the dimensions may be readily identified by a viewer.

Other information may be shown in connection with a multi-dimensioned, ordered data set illustrated as a set of concentric rings. Other information, including dimensions or other information that does not share the same ordinal as the dimensions depicted by rings, may be depicted in other ways. In some embodiments, such other information may be depicted in a display region, such as a column resembling an axle through the wheel. Display characteristics of that display region may be set to represent data values of the other information. For example, an aggregate value for one or more dimensions may be represented by a column centered at the plurality of concentric rings. As with values represented by thickness of the rings, the distance that the column extends above a nominal reference plane may indicate the magnitude, with a positive sign, of a particular variable. Conversely, the distance that the column extends below the nominal reference plane may indicate the magnitude, with a negative sign. A height of a column may provide an indication of an aggregate value of data values from one or more dimensions. In some embodiments, a column may be positioned relative to a plane of the plurality of rings such that the plane of the plurality of rings corresponds to a specific value. The height of the column lying perpendicular to the plane may provide an indication of the aggregate value represented by the column. For example, the plane of the plurality of rings may correspond to zero and a height of a column perpendicular in one direction of the plane may correspond to a positive aggregate value while a height of a column perpendicular in the opposite direction may correspond to a negative aggregate value.

A computerized system may produce such a visual representation by generating a three-dimensional graphical model of the plurality of concentric rings and displaying an image illustrating a view of the graphical model on a display. A graphics rendering component of a computing device may be configured to generate the three-dimensional model and/or the image. Graphics rendering components, capable of determining appropriate display values to depict a view of an object represented by a three-dimensional model are commercially available. Accordingly, by representing the data in a three-dimensional model, conventional processing components may be used to display views of the three-dimensional model. The resulting image may be transmitted to any suitable display either part of the computing device or a separate display device.

The inventors have further recognized and appreciated that providing a system that accepts user inputs, which impact the display of data, may facilitate user understanding of the data. In some embodiments, the user inputs may modify the manner in which the data is displayed. Alternatively or additionally, user inputs may modify the data on which the data is displayed. As yet a further alternative, which may be used alone or in combination with other user manipulations, user input may specify other information displayed in connection with a display of data.

In some embodiments, user inputs may modify views of the three-dimensional model displayed. By representing the multiple dimensions in a three-dimensional model as described herein, currently available computing equipment can generate displays dynamically, sufficiently in real-time, to enable user manipulation of the representation to see characteristics of one or more data dimensions and/or to explore relationships of the data. A system, in accordance with some embodiments, may receive user input indicating manipulations of the three-dimensional model, such as moving, rotating, and/or changing zoom levels of the model. Updated images of the views may be generated such that the views the updates in real-time. Such updates may result in a transition from a first to a second view of a three-dimensional graphical model being presented on a display as a moving real-time transition that responds to real-time interactive user controls.

A system may alternatively or additionally support other manipulations of the manner in which the data is displayed. For example, the user may also modify the format of the three-dimensional model such that the plurality of rings is unwrapped into a linear arrangement and/or a section of the model is separated from the remaining portion of the model. These techniques may allow a user to modify the visual representation of the data in a manner that improves the user's interpretation and understanding of the data.

In embodiments that support user manipulation of data values, the system may include one or more user interfaces that allow the user to specify changes to the data values. In embodiments that support data presentation, the system may accept user input associating metadata in any suitable form with particular data values. The system may also include an input mechanism by which a user may indicate a display element, associated with a data value, in response to which the system may present the metadata.

Examples of data visualization operating in accordance with techniques explained above are described below, but it should be appreciated that the examples are provided merely for purposes of illustration and other implementations are possible.

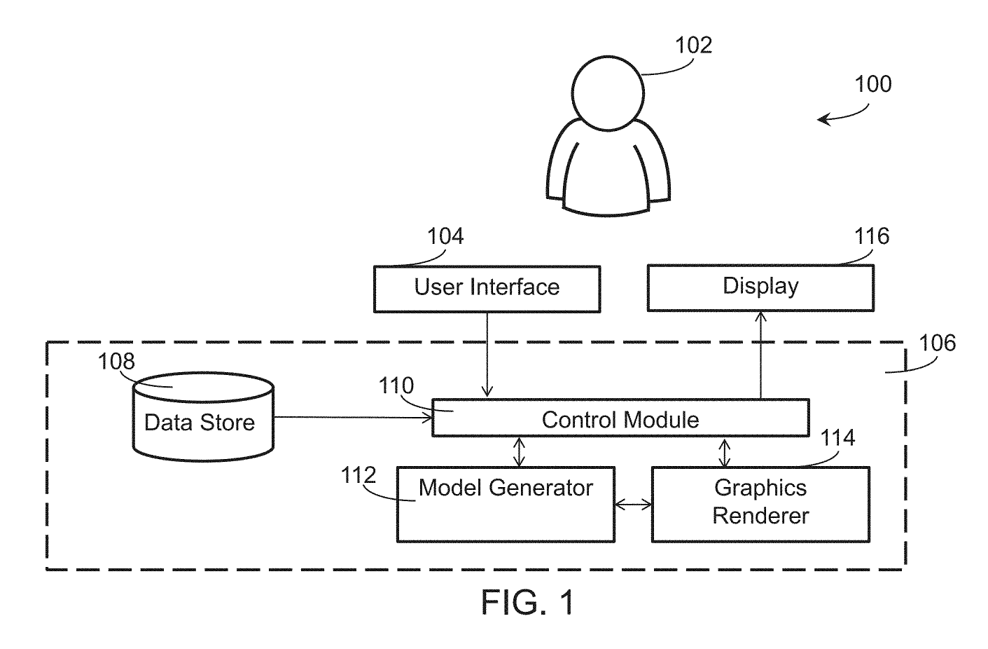

FIG. 1 illustrates an exemplary embodiment of a system 100 for visualizing data. Such a system may operate on data from one or more sources and present it in a visual form. The system 100 includes user interface 104 that is a component of and/or in communication with computing device 106. The user interface may be any suitable user input tool or tools, such as a mouse, tracking pad, keyboard, pointing device, touchscreen, speech input device, devices with multi-dimensional tracking capabilities (e.g., Polhemus tracker), and/or any other type device or component configured to receive user input. The system also includes display 114 that is a component of and/or in communication with computing device 106.

Using techniques described herein, the system 100 may generate a three-dimensional graphical model of data and display an image of the three-dimensional model on display 112. The display may be any suitable type of display such as a screen on a desk top computer, phone, tablet, or other mobile device. Alternatively or additionally, the display may be a stereoscopic visualization device, head mounted display, heads up display, virtual glasses, or any other type of device capable of displaying computer generated three-dimensional models.

Alternatively or additionally, display 116 may be a device that prints a model, such as a paper printer or a 3-D printer. In embodiments where display 116 is a printer, display 116 may receive data indicative of the three-dimensional model generated by system 100 and print, depending on the type of printer, a physical format of the model. In this manner, a user may print using a three-dimensional printer a physical object representing the three-dimensional model.

Data visualized by data visualization system 100 may be received by computing device 106 in any suitable way. As shown in the example of FIG. 1, user 102 may operate user interface 104 to provide input for computing device 106. Examples of user input devices that can be used as a user interface include keyboards, touchscreens, and pointing devices such as mice. User 102 may input data for computing device 106 directly through user interface 104. In some embodiments, user interface 104 is the same as display 116, such as in embodiments having a touch screen, allowing the user to provide input data and/or instructions on the same screen in which the three-dimensional model is displayed.

Data for visualization alternatively or additionally may be retrieved from data store 108. Data store 108 may be part of computing device 106 or an external storage device which can be accessed by computing device 106 by any suitable manner of data communication. An external storage device having data store 108 may be accessed by computing device 106 thorough wired and/or wireless communications. The external storage device may be a computer-readable storage medium configured to be read by computing device 106. User 102 may provide input through user interface 104 indicating a selection of a subset of data stored on data store 108 for visualization by data visualization system 100. The user input may specify which data is to be retrieved and processed by computing device 106. Alternatively or additionally, user input may specific characteristics of that data, such as which portions represent data values for different dimensions and ordinal values, defining an order to the data values.

The three-dimensional model may express relational information organized in multiple dimensions. In some embodiments, the relational information may be ordinal information, indicating, for values in each of multiple dimensions, a value of a common ordinal for the dimensions. For example, dimensions may be related by an ordinal such as time or by a sequence number of an event stream. Data within a dimension may comprise a set of values having the same type of information. For some dimensions, data values within a dimension may correspond to data within a category of information, such as profit, loss, expenses, sales, number of participants at an event, etc. In some embodiments, the sequence of data in a dimension is a time sequence.

However, it should be appreciated that time is only one example of an ordinal value and visualization techniques as described herein may be used in connection with any type sequence of data. Other ordinal values may also be used, such as largest, second largest, third largest, etc. In such an embodiment, data values may be ordered based on the relative magnitude of the data values such that the data values are ordered in a series of increasing or decreasing order. Alternatively, data for a dimension may contain values corresponding to units of information, and the values may be visualized in a series indicating individual information related to each unit. For example; values around the concentric rings may each represent one house within a subdivision of many houses while the concentric rings may may represent values representing a schedule of completion of construction categories: foundation, walls, ceiling, electrical, plumbing, etc. Relationships between data values across dimensions may be maintained when data values for a dimension are ordered. For an example, data values in a table may be ordered by arranging rows of data values in the table such that values for a certain column are in a particular sequence to maintain the relationship among the data values within the particular rows. Moreover, it is not a requirement that each data value in a sequence be indicative of the same type of information.

Information may be stored in data store 108 in any suitable format. In some embodiments, information may be stored in a structured data format. Examples of structured data formats include databases, tables, spreadsheets, forms, relational databases. The structure may define both the dimensions and relationships between the values in different dimensions. For example, information may have a table format where the columns of the table represent different dimensions. A column of the table may represent data values for a category of information, while rows of the able may represent related data values across multiple categories of information. Each row, for example, may correspond to a different value of an ordinal, such as time or a sequence of events, and data values for a dimension may be ordered by arranging the data values within the column in a particular sequence in accordance with an ordinal value.

In accordance with some embodiments, data store 108 may store multiple versions of the data. For example, the system may separately store input data and data being displayed. The data being displayed may, initially, be a copy of the input data. However, in embodiments in which a system accepts user inputs manipulating the data being displayed, those inputs may modify the copy being displayed, without altering the version of data that was initially input. Further versions of the data may be stored in a system that accepts a user input to store a “scenario” created by user modification of the data.

In some embodiments, a copy of data being displayed may be stored as a table with relationships between data elements represented by cells in the table. Such a representation, for example, enables a user to provide inputs modifying a data value and seeing the impact on other data values that are derived from or related to that modified data value. Such a representation may be in the form of a spreadsheet program in which an equation, dependent on values in other cells, may be specified for a cell.

However, it should be appreciated that it is not a requirement that data be stored in a spreadsheet or ordered in a table. In some embodiments, data values may be formatted as tuples. Each tuple may indicate a value in one or more dimensions and a value of one or more ordinals. In such an embodiment, visualization of the data may entail sorting and ordering the tuples to identify relationships between values in different dimensions for display.

Regardless of the format in which the data is received by computing device 106, model generator 112 may generate a three-dimensional model of the data. The model may depict one or more dimensions using a “data wheel” as described herein. That three-dimensional model can be presented to graphics renderer 114 and displayed, such as on display 116.

In some embodiments, computer 106 can be programmed to respond to user input indicating changes to the data. Accordingly, a three-dimensional graphical model may reflect a modification of one or more data values. Computing device 106 may receive updates and/or additions to data for visualization and update an image of a graphical model representing the data including the updates and/or additions. User 102 may edit a display copy of an existing data set through user interface 104, and an image of a graphical model representing those edits may reflect the edited data. In embodiments in which data is stored in a format that includes relationships between data values, user input changing one data value may trigger an update, in accordance with the stored relationships, of other data values. As a specific example, a data set may include data values representing profits and expenses. A relationship may reduce the value stored as profits as the value stored as expenses increases.

Computing device 106 may access updates to data stored in data store 108 (e.g., through real-time data acquisition), for visualization of the updated data. Information stored in data store 106 may be updated occasionally, periodically, or continuously (e.g., as the information is received), and the updated data may be retrieved by computing device 106 for visualization. In some embodiments, model generator 112 may generate a new three-dimensional graphical model reflecting the changed data values received by computing device 106, and the updated image may represent the new three-dimensional graphical model including the updated data values.

In addition to inputting data or selecting a data location, user 102 may provide input through user interface 104 regarding parameters of a visual representation of the data. Such parameters may include content selection (such as which dimensions to display), color, rendering methods, location, scale, and/or rotation of an image portraying a view of a graphical model representing the data. User 102 may modify a characteristic, and the modified characteristic may be reflected in the image.

Computing device 106 may include control module 110 to facilitate transfer of information between computing device 106 and user interfaces such as user interface 104 and display 116. Control module 110 may collect information regarding the input data for visualization from user interface 104 and transmit the information to model generator 112. Control module 110 also may collect information regarding parameters for visualization from user interface 104 and transmit the information to graphics renderer 114. In some embodiments, control module 110 may be a software user interface (e.g., graphical user interface), a component of control software of computing device 106 (e.g., a component of an operating system), or a component of an application such as a plug-in to an application. Embodiments are not limited to implementing control module 110 in any particular manner.

In the example of FIG. 1, computing device 106 includes model generator 112 and graphics renderer 114. The model generator 112 receives data for visualization from control module 110. In some embodiments, model generator 112 may receive that data in the form of a data table comprising a series of columns and rows. However, as noted above, the data may be in any suitable format. Model generator 112 constructs a three-dimensional model of the data comprising a plurality of rings. The diameters of the plurality of rings may vary such that the rings are concentric where the different rings correspond to different dimensions of the data. In this manner, multiple dimensions of information may be represented at once in a three-dimensional model by having different rings corresponding to each of the multiple dimensions of information.

A ring may correspond to a particular dimension such that data values for the dimension are represented in a radial direction around the ring. A ring may be sized to represent the magnitude of the data values of the dimension. In some embodiments, the sizing in a direction perpendicular to the radial direction may represent the data values. Variations in elevation of a surface of the ring may correspond to variation in the magnitude of data values. In some embodiments, bars, such as in the form of a bar graph, representing individual values of data in a dimension are organized at different radial positions around the ring, and variation in the height of the bar graphs provides an indication of variation in magnitude of the individual data values. Bars or other graphical objects may project from a ring in more than one direction to indicate variation in data values from a central value. In some embodiments, projections from a ring may be perpendicular to the plane of the ring such that the plane of the ring indicates a central value and positive or negative deviations from the central value are indicated by projections above and/or below the plane of the ring. For example, the plane of the ring may correspond to a data value equal to zero and positive data values may be represented by projections on a first side of the ring (e.g., top side) while negative values may be represented by projections on another side of the ring opposite to the first side (e.g., bottom side).

The plurality of rings may lie in the same plane of the three-dimensional model such that variation in data values may be represented by deviations from the plane having the plurality of rings. A ring may not be fully closed (i.e. spanning exactly 360°) and, in some embodiments, may span less, such as only 270°, or more, such as 720°. In the latter case, the “ring” may appear as a spiral, with each ordinal value represented by a particular radius from the center of the ring and a specific angle. In this way, different ordinal values may have the same angular value, but different radial values. As a specific example, data values that correspond to different points in time may be represented around a ring such that the passage of time is depicted by different values at different positions in either a clockwise or counterclockwise direction around the ring.

The three-dimensional model may include a representation of an aggregate value, from one or more rings, or a value from any other source. The aggregate value may include an average value, a summed value, a median value, or any other suitable type of value to indicate a representation of an aggregation of multiple data values. User 102 may provide input through user interface 104 and control module 110 may transmit information regarding an indication to aggregate one or more dimensions to model generator 112. A representation of the aggregate value may be located in a central region such that the plurality of concentric rings is centered on the central region. Such an aggregate value may be depicted in the three-dimensional model in any suitable way. In some embodiments, the three-dimensional model includes one or more central columns located proximate to the central region. The one or more columns may be positioned perpendicular to the plurality of rings to indicate one or more aggregate values.

Model generator 112 may be implemented in any suitable way. In some embodiments, model generator 112 may be known CAD software or software that configures computing device 106 to generate a three-dimensional model of an object described by multiple data values. Though such software may be designed to represent solid objects, such software, or the same techniques used by that software, to represent solid objects, may be used to program computing device 106 to generate a three-dimensional model representing data in multiple dimensions as a wheel as described herein.

Regardless of how the model is generated, an image of the three-dimensional model generated by model generator 112 may be rendered by graphics renderer 114 and displayed on display 116 to user 102. Graphics renderer 114 may construct an image of the three-dimensional model. Graphics renderer 114 may be implemented as software executing on a processor within computing device 106. Alternatively or additionally, graphics renderer 114 may be a graphics processing chip or other suitable component for generating a displayable image from a three-dimensional model.

Display 116 may be part of computing device 106 or a separate device such as a mobile device (e.g., mobile phone, tablet, watch, glasses, and clothing). Information related to the image may be passed from graphics renderer 114 to display 116 through control module 110. Control module 110 may be a component of control software for computing device 106 (e.g., a component of an operating system) or a component of an application such as a plug-in or a web-based application where a user may access information related to a three-dimensional model over a network. Embodiments are not limited to implementing the control module 110 in any particular manner.

Attributes of the displayed image may be configured by information received by control module 110 and passed to graphics renderer 114. Graphics renderer 114 may implement the information in constructing the image. The image may be outputted by graphics renderer 114 to display 116. The information outputted by graphics renderer 114 may include parameters such as color, size, location, geometry, shape, transparency, texture, and any other suitable rendering characteristics. Such attributes of the three-dimensional model may have default values and/or be selected by user 102.

User 102 may indicate a particular parameter by providing user input through user interface 104, such as by selecting a portion of a displayed image. The user input may indicate a desired attribute of the three-dimensional model such as a particular position and dimension of the model, a rotated and/or scaled view of the three-dimensional model representing the data, a selected color of one or more aspects of the three-dimensional model such as rings and/or center columns. As another example, the information may indicate a perspective from which the three-dimensional model is depicted. For example, a user wishing to gain greater insight into time periods during which negative financial results were recorded may specify a point of view that depicts the three-dimensional model being displayed with the bottom portions, containing negative values, most visible.

User input provided by user 102 may indicate changes to one or more parameters which may alter the manner in which the three-dimensional model is displayed, such as moving, rotating, and/or resealing the three-dimensional model. Changes to a parameter may be passed by control module 110 to graphics renderer 114. In response to user input, model generator 112 may generate a new model or graphics renderer 114 may construct an updated displayed image of the three-dimensional model to reflect updates to parameters or changes based on other user input. Information indicating updates to parameters may be passed to model generator 112 and/or graphics renderer 114 occasionally, periodically, or continuously (e.g., as the information is received). In some embodiments, a time between when user 102 provides an input and when an updated image is displayed may have a length where user 102 perceives updates to the displayed image in real-time. In this manner, user 102 may interact with the three-dimensional model through user interface 104 to alter the view of the model visually represented on the display in a way that may improve interpretation of the data values.

In some embodiments, an indicator identifying a ring corresponding to a particular dimension of the data may be presented. The indicator may include a legend where a dimension is associated with a particular characteristic such as color, hue, and/or pattern used to depict the corresponding ring in the displayed image. User 102 may provide input indicating selection of the characteristic which may be passed to model generator 112 and/or graphics renderer 114 through control module 110. In this way, the user may control the visual characteristics of the display.

In some embodiments, the information from graphics render 114 may include metadata associated with one or more data values represented in the three-dimensional model. This metadata may be specified in any suitable way at any suitable time. For example, a first user viewing data may have observations about the data, which can be captured as metadata input by the first user. The metadata may be provided, for example, as a data tile (e.g., text tile, video file, audio file) or a link to information stored in a data file (e.g., a hyperlink). The data file may provide additional information related to its associated data value(s), such as an information explanation of the data point. A second user interacting with the image of the three-dimensional model may access the metadata associated with a data value. The second user may access the data by making an input in connection with the three-dimensional model, such as by clicking or hovering with a cursor over the data value of interest or selection using a virtual tool in an immersive environment visualized with the use of a head mount display or virtual glasses.

Additional information may be presented along with the displayed image. Model generator 112 and/or graphics renderer 114 may receive instructions indicating the type of information to present along with the displayed image and parameters related to how the information is displayed. What information is displayed and/or its format may be specified based on user input, such as input received by user interface 104, and control module 110 may pass those instructions to model generator 112 and/or graphics renderer 114. In some embodiments, a user may provide input as selecting a region of the displayed image corresponding to a portion of the three-dimensional model and additional information related to the portion may be presented. The additional information may be retrieved from metadata associated with the portion of the three-dimensional model. Model generator 112 may receive instructions based on the user input and update the model or generate a new model to include the additional information. Additionally or alternatively, graphics renderer 114 may receive the instructions and update the displayed image to include the additional information, especially where the three-dimensional model is unchanged.

As an example, textual information regarding information about one or more data values may be presented along with the displayed image. Graphics renderer 114 may receive instructions to display the textual information on the displayed image as a text box listing the specific data values for one or more positions corresponding to the three-dimensional model. The textual information may provide an explanation of the specific data values. For example, the textual information may offer an explanation of why a particular data value is an outlier in comparison to other data values represented by the three-dimensional model. It should be appreciated that other types of information, including audio and visual information, can be displayed to a user in association with one or more data values represented by the three-dimensional model.

The data visualized by the data visualization system may have relationships between multiple dimensions. In some embodiments, the data may have the format of a spreadsheet where individual columns within the spreadsheet correspond to different dimensions of the data and there may be relationships between multiple columns. For example, a first column may include data corresponding to revenue of an enterprise, a second column may include data corresponding to costs of the enterprise, and a third column may include data corresponding to profits of the enterprise by taking a difference between the data in the first and second columns. The data visualization system may, in some embodiments, have a feature that allows a user to investigate how changes in data for one or more dimensions impact other dimensions based on the relationships between the dimensions. A copy of the original data set may be made to maintain an unchanged version of the original data set. A user may alter the copy by providing input, by changing the data values directly and/or by selecting and manipulating a portion of the three-dimensional model presented on display 116. In this manner, there can be a two-way exchange of information between the image of the model on display 116 and the data values used to generate the model by model generator 112 such that the data values can be changed both by entering in the data values directly and by manipulating the image of the three-dimensional model through user input.

In some embodiments, user input may indicate that some or all of the displayed data be presented in an additional format other than as a data wheel. Accordingly, in some scenarios, a second visual representation of a model depicting the data values may be generated and displayed. The additional formats may ease interpretation of the data values by providing alternative models and/or views of the data values.

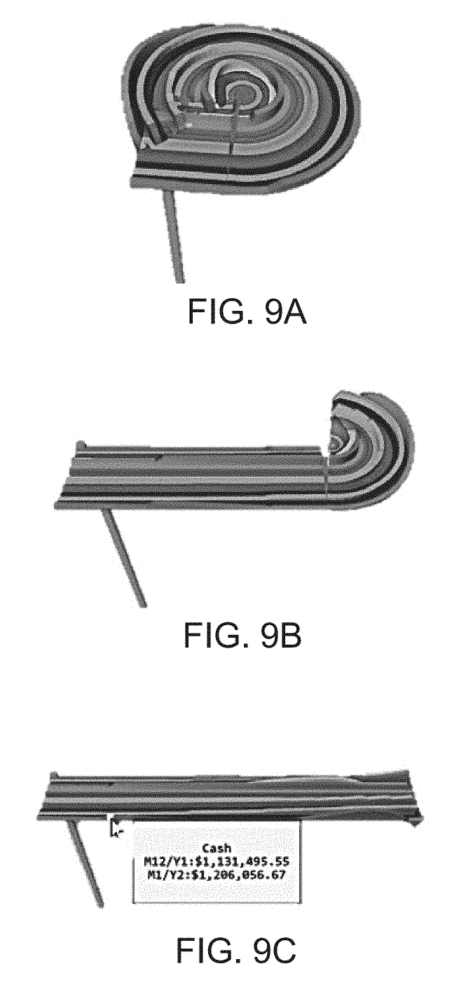

As a specific example, in some embodiments, model generator 112 may generate an unwrapped model of the three-dimensional model such that each ring of the plurality of concentric rings is represented linearly. That visualization may appear static to the user, appearing all at once as a linear representation. Alternatively, the visualization may be generated dynamically, using computer animation techniques to show the ring or rings of the data wheel unwrapping. An example, showing the unwrapping at various stages is described, for example, with reference to FIGS. 9A-9C. In some embodiments, model generator 112 may generate an expanded model of the three-dimensional model such that segments of each ring are positioned outwards from a central point. An expanded view may allow user 102 to distinguish between data values.

Model generator 112 may receive instructions specifying a model format and generate a three-dimensional model with the model format specified in the instructions. Control module 110 may provide instructions related to model format to model generator 112 and may pass the instructions based on user input. Graphics renderer 114 may construct an image of the three-dimensional model generated by model generator 112 using the format specified in the instructions, such as an unwrapped view and/or an expanded view. To illustrate progression between different model formats, model generator 112 may generate a series of three-dimensional models between the different formats, and graphics renderer 114 may construct a series of images by displaying the series of three-dimensional models from one format to another format, such as between a plurality of concentric rings to an unwrapped format, and display the series of images on display 116. In some embodiments, graphics renderer 114 may receive instructions from control module 110 regarding a change in format of the three-dimensional model and construct a series of images illustrating the three-dimensional model changing from one format to another. Regardless of how the series of images is constructed and displayed, the images may represent an animation between different model formats and may ease the interpretation of the data values represented by the three-dimensional model by providing alternative representations of the same data. User 102 may provide user input through user interface 104 as an indication to display an image of an unwrapped model illustrating a view of the unwrapped model in a three-dimensional environment.

Additionally or alternatively, a visual representation of a three-dimensional model may include one or more portions of data separate from the three-dimensional model. A portion of data values of the three-dimensional model may include a slice of data values from multiple rings of the plurality of concentric rings. The portion may include data values from different rings such that the data values correspond to different categories of information. A slice may include data values for one or more dimensions that share the same ordinal value, such as the same time point or sequence number. An image including the displayed image of the three-dimensional model and a portion of data values separate from the three-dimensional model may be constructed by graphics renderer 14 and displayed on display 116. In some embodiments, model generator 112 may regenerate a model where the portion of data values is separated from the rest of the three-dimensional model. By separating out a selected portion of the data values, user 102 may view details corresponding to specific data of a three-dimensional model. Control module 110 and/or graphics renderer 114 may receive an indication of the slice or portion of data values to present as separate from the three-dimensional model. As an example of a possible implementation, control module 110 may receive from an operating system of computing device 106 an indication of user input identifying a portion of the displayed image with a slice of data values. Control module 110 may interact with both graphics renderer 114 and model generator 112 to determine which portion of the three-dimensional model is displayed at that location and which portion of the data is depicted in that portion of the three-dimensional model. With this information, control module 110 may identify the data selected by the user and pass to model generator 112 instructions to generate a model where the portion of data values selected by the user is separate from a three-dimensional model representing the remaining data. Graphics renderer 114 may construct an image of this updated three-dimensional model generated by graphics generator 112.

The data visualization system may have a feature that records manipulations of data values and/or representations of the three-dimensional model. The recording may be stored, such as in data store 108, in any suitable format. The recording may be played back, at a later time, possibly by a different user, to demonstrate the effects of manipulation of the data. Such a feature, for example, may enable a user to create a presentation relating to a data set and impacts of changes or differences in the data set for later presentation to others. Such a feature, for example, might be used where the data set represents financial results of a business. A recording of various manipulations may be used to create a presentation of how changes in specific business operations would have or might in the future impact the business.

For example, in some embodiments, a recording of subsequent images generated by graphics renderer 114 may be stored as a video file which can be viewed without a user having to reenter data values or commands used to generate the images. The video file may be inserted into another document or file, such as a presentation or webpage. In some embodiments, the recording feature may record a series of commands received by model generator 112 to construct the three-dimensional model. As a user provides input indicating changes to the data values and/or representation of the three-dimensional model, commands associated with those changes are stored as part of the recording, which may be referred to as a “macro.” The macro may be implemented at a later time on the same data set or a different data set to perform the recorded series of commands. A user may initiate, pause, and stop recording of the images generated by graphics renderer 114 and/or the commands received by model generator 112 at any time while interacting with the three-dimensional model.

For ease of explanation, examples set forth below will be described with reference to components of the system 100 of FIG. 1. It should be appreciated, however, that embodiments are not limited to operating in the exemplary environment of FIG. 1 or in similar environments.

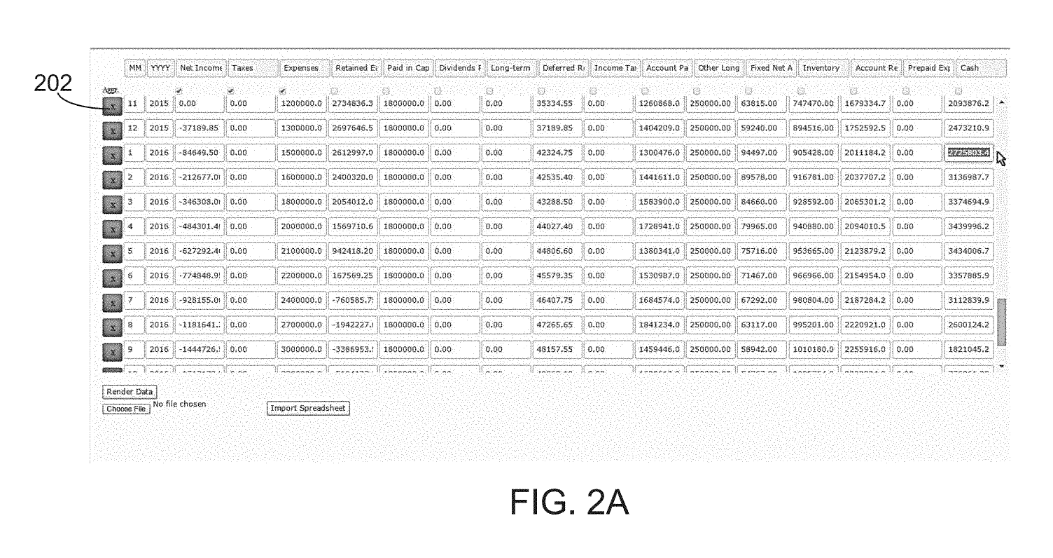

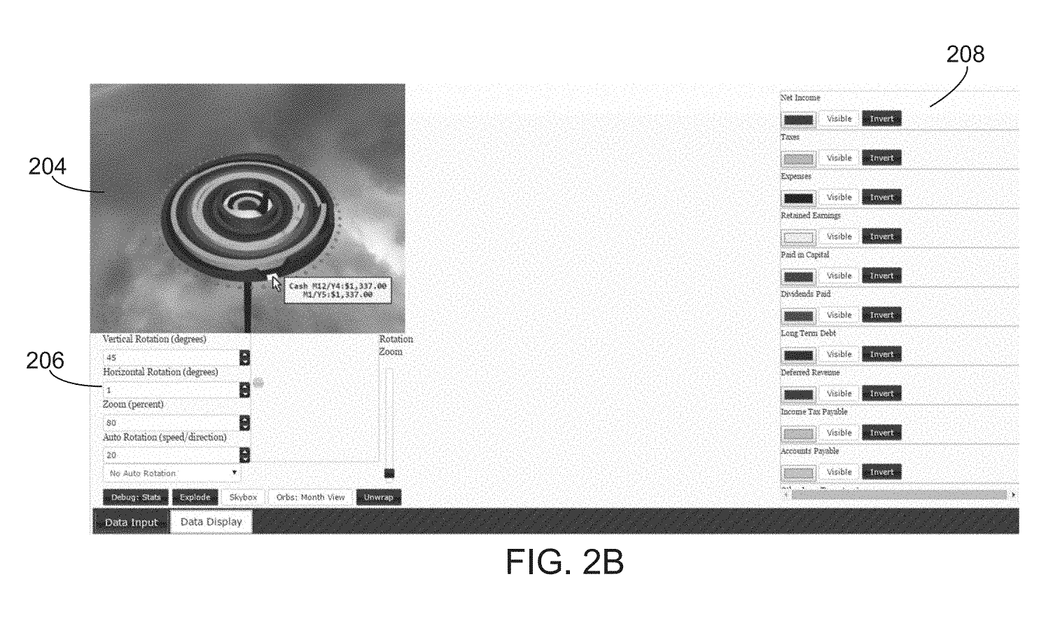

In some embodiments, control module 110 may include a software user interface such as a graphical user interface to transfer information between user interface components and software components of computing device 106. A graphical user interface may facilitate receiving and/or updating input data for visualization by displaying selected input data on display 116. User 102 may directly input and/or modify data through the graphical user interface. FIG. 2A is an exemplary data input graphical user interface. As shown in FIG. 2A, the graphical user interface comprises a data table having a series of columns and rows. The first two columns correspond to categories of month and year, respectively. The remaining columns correspond to categories of financial information. The first row indicates the category names for the different columns, and in the example data shown in FIG. 2 the categories relate to different types of financial information including “Net Income,” “Taxes,” and “Expenses.”

User 102 may edit individual entries in the data table and/or add additional entries such as by adding additional rows and/or columns to the data table. For example, a “+” button may initiate addition of a row when selected by user 102 while a “×” button, such as 202 in FIG. 2A, located next to a row may initiate deletion of the row when selected by user 102. A graphical user interface with such a button may be implemented in any suitable way, including using techniques as are known in the art. An operating system of computing device 106, for example, may map such a button on a screen to a specific function entry of control module 110. When a user provides input through the graphical user interface indicating selection of the button, that function entry may be invoked, causing a function corresponding to the button to be performed.

Such a graphical user interface may additionally include a control that enables a user 102 to access data stored on data store 108 through the graphical user interface such as by importing information from a data the (e.g., spreadsheet). The graphical user interface may provide an option for a user to choose a data file, such as the button “Choose File” shown in FIG. 2A. The user may be prompted to select a data file having a format suitable for importing into the data table (e.g., spreadsheet). When a file is selected, the data in that file may be presented through an interface as shown in FIG. 2A, enabling a user to edit the data stored in the file.

An example of a formatted spreadsheet may include a row (e.g., the second row of a table) containing header information for each of the columns. A formatted spreadsheet may also include a column containing identification information for each row such as and identification number. In some embodiments, a predetermined number or rows may be included. In some embodiments, control module 110 may implement converting data files into a suitable format for input to model generator 112. User 102 may select “Import Spreadsheet” to fill the data table with the data from the selected data file (e.g., spreadsheet).

The graphical user interface may also provide an option for a user to initiate modeling and rendering of selected data. Upon selecting the option, graphics renderer 114 may construct an image depicting an image of the three-dimensional model. As shown in FIG. 2A, a user may select “Render Data” to initiate rendering of the data provided in the data table.

A different graphical user interface may be displayed on display 116 having the image constructed by graphics renderer 114. The graphical user interface displaying the image may have any suitable arrangement and may be arranged to facilitate user interaction. Any suitable user interface techniques may be used to enable a user to input commands identifying what portions of a model should be displayed or how that data should be displayed. FIG. 2B is an exemplary data visualization graphical user interface. As shown in FIG. 2B, the graphical user interface comprises a model display region 204 configured to display the image of the three-dimensional model constructed by graphics renderer 114. User 102 may select portions of the displayed image and control module 110 may pass commands to model generator 112 and/or graphics renderer 114.

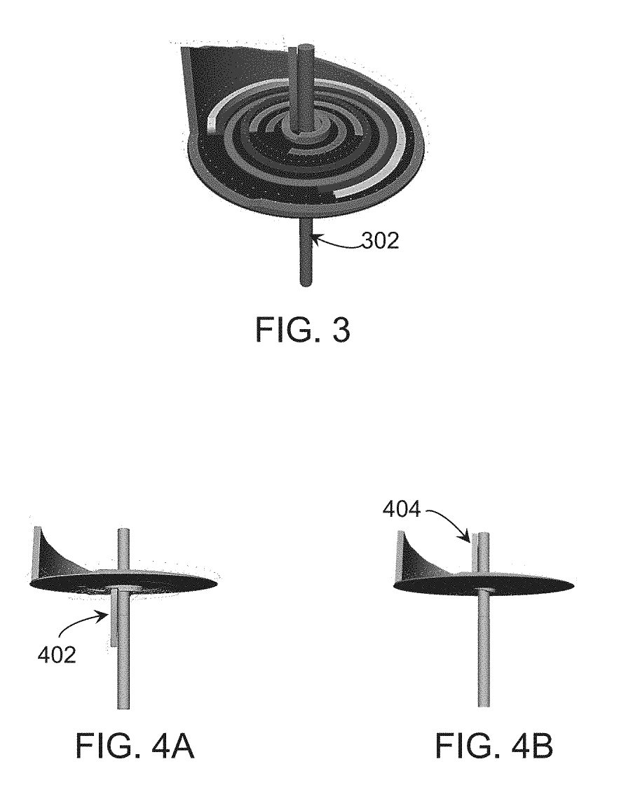

As discussed above, a visual representation of data values may include a plurality of concentric rings where each ring corresponds to a different category of information of the data values. FIG. 3 illustrates an exemplary visual representation that may be displayed in a graphical user interface according to aspects of the present application. As shown in FIG. 3, the rings may vary in color to distinguish among the different categories, and the data values for a category may be depicted around the ring such that the apparent size of the ring illustrates the magnitude of the data values. In FIG. 3, the outermost ring has an increasing height going counterclockwise around the ring, which represents an increasing magnitude of the data values for the category corresponding to the ring.

A visual representation may also include one or more columns positioned and centered at the plurality of concentric rings such as column 302 in FIG. 3. The one or more columns may display one or more aggregate values of a portion of the data values. User 102 may indicate a selection of a portion of data values to include in an aggregate value and the aggregate value may be represented as a column in a visual representation. For example, the data input graphical user interface shown in FIG. 2 includes a series of boxes under each category name, and user 102 may select one or more boxes to identify the data values for determining an aggregate value. The data values for the categories selected may be averaged and an average value may be represented by a column positioned at the center of the plurality of concentric rings. A centered column may be positioned on either side of a plane having the plurality of rings to represent the magnitude and/or sign of an average value. For example, a column positioned on one side of the plane may correspond to a positive aggregate value while a column positioned on the opposite side may correspond to a negative aggregate value such that the plane corresponds to zero value. A positive and/or negative side may correspond to a relative orientation of the three-dimensional model in an image such that a user viewing the image may interpret above a plane of the rings as a positive value and below a plane of the rings as a negative value. In some embodiments, a user may select an option for which side of the plane to represent positive and/or negative values to position a column depicting an aggregate value according to the user's preference. For example, FIG. 4A illustrates column 402 below the plane of the rings while FIG. 4B illustrates column 404 above the plane of the rings.

In some embodiments, the graphical user interface may comprise one or more control sections for particular functions and/or controls for altering the format and/or view of the three-dimensional model and/or the data underlying the model. A control section may display the three-dimensional model and may include an option for initializing viewing of the three-dimensional model. A control section may comprise a series of controls and indicators for parameters to modify a view of the three-dimensional model in a displayed image. The control section may include possible options for modifying the view and/or format of the three-dimensional model such as zoom and rotation of the three-dimensional model. For example, the graphical user interface may include a set of text boxes showing the model's current vertical and horizontal rotation measured in degrees. Changing the values displayed in these text boxes may update the model's rotation in an updated image. As shown in FIG. 2B, a graphical user interface may include a control section, such as region 206, comprising a series of controls and indicators for parameters to modify the displayed image. In the example shown in FIG. 2B, region 206 of control section includes controls for vertical rotation, horizontal rotation, zoom, and auto rotation. For example, the graphical user interface shown in FIG. 2B includes a text box displaying a current zoom level of the model. For example, the zoom level may range from 25% to 800%. The control section shown in FIG. 2B also includes a control fir auto-rotation which displays a series of images illustrating progressively rotated views of the three-dimensional model is displayed. The control may include an option to initialize auto-rotation, which may be activated and deactivated by a user. Additional auto-rotation options may include a direction of rotation such as vertical and horizontal directions and a speed controller to control the speed of rotation over a range. A control section may include an option to initialize rotation of the three-dimensional model in response to user input. For example, a rotation control may include an area of the graphical user interface illustrated as an object such as a cube where the user provides input for rotating the model by clicking and dragging the object. A control section may include zoom controls where a user can select a zoom level. A zoom control may be represented by a box slider graphic.

A control section may include options for depicting the data values in the displayed image such as color, visibility of dimensions, direction of data values for a dimension represented in a ring, and/or designation of the size of the rings, such as region 208 in the graphical user interface shown in FIG. 2B. A color scheme for a visual representation may indicate may indicate particular categories of information corresponding to particular rings. The color scheme may improve ease of interpretation of the data values for a user by having colors identify certain categories of information. Through the control selection, a user may select and/or update colors for rings displayed in an image. As shown in FIG. 2B, a user may select the “Visible” option to designate a particular dimension as visible in the displayed image of the three-dimensional model. A user may also provide input indicating the direction of positive or negative data values represented in the model, such as by the “Invert” option which inverts the directionality of the data values for a dimension. For example, if positive data values are portrayed on the top side of the model as a default setting, selection of a dimension to invert may reverse the direction of data values such that positive values are represented on the bottom side and negative values represented on the top side.

Other aspects of the control section may enable a user to control which data is displayed. For example, a control section may include options for selecting the visibility of one or more dimensions in a visual representation. A dimension may be indicated as visible in a visual representation through a user selecting an option on a control section. A user may activate particular dimensions to include in a visual representation and may deactivate particular dimensions to exclude from a visual representation. In this manner, a user may control whether certain options are visible by selecting options in a control section of the graphical user interface. A control section may include an option designating a direction for positive and/or negative values within a representation. In some embodiments, a positive direction may point up within a visual representation and an option in a control section may include inverting the direction, such that when the option is selected the positive direction points down within the visual representation. In this manner, a user may alter a direction or a column indicating an aggregate value by selecting the option. Such an option may allow the user to improve ease of viewing the information corresponding to the data values.

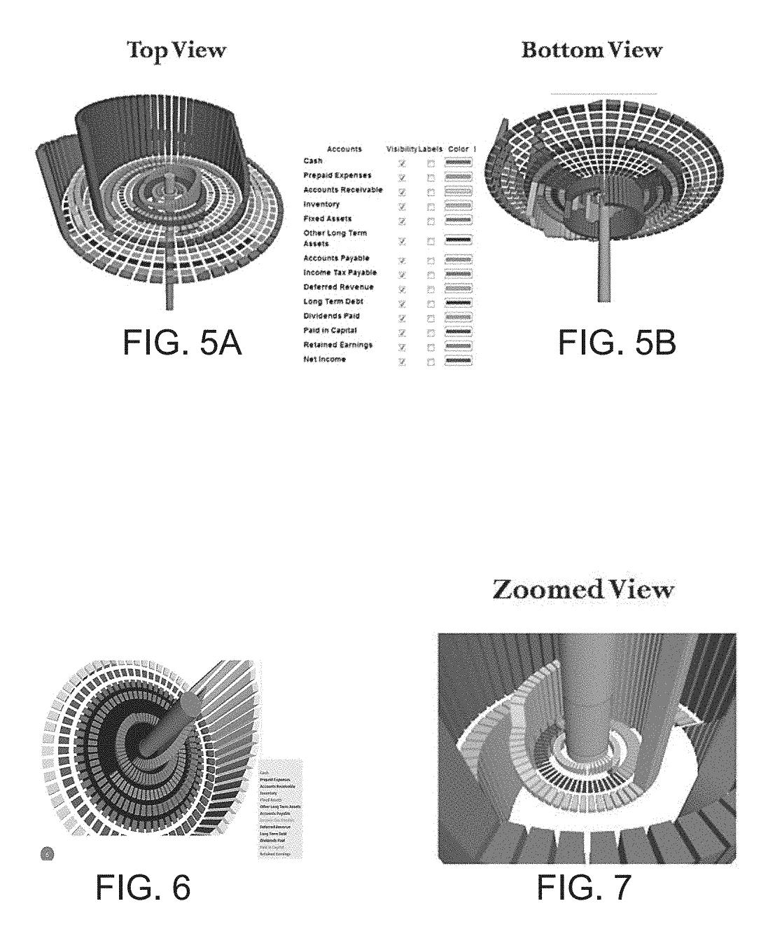

A control section may include options for selecting different formats of a three-dimensional model. The different formats of the three-dimensional model may include activating a background, generating an unwrapped view, and/or generating an expanded view. In some embodiments, a control section may include an option for including a background image or graphic to the three-dimensional model. In some embodiments, a control section may include an option for selecting an unwrapped view of a three-dimensional model. A user may select the option and an animation sequence of images illustrating rings of a three-dimensional model unwrapping into a linear array such as a bar graph. In some embodiments, a control section may include an option for expanding one or more segments of a three-dimensional model from a central point. For example, FIGS. 5A-B are images of three-dimensional models with an expanded view such that the rings are segmented. A segment may correspond to a data value. In this manner, a segmented view may allow a user to visualize individual data values within the visual representation. In some embodiments, a segment may correspond to a particular point in time (e.g., month) and a control section may include an option to select a segment and activate a slice view of the segment that removes and separates the segment from the three-dimensional model. Data values in the segment may be represented as a bar graph, and the bar graph may be depicted separate from the three-dimensional model.

A visualization system may enable a user to select different views of a three-dimensional model by moving, rotating, exploding, and/or changing a zoom level. Commands to invoke these functions may be supplied using any suitable graphical user input commands, such as clicking a mouse button and rolling a mouse wheel. For example, FIGS. 5A and 5B are visual representations of different views of a three-dimensional model. FIG. 5A is a top view and FIG. 5B is a bottom view, illustrating that individual rings may be sized such that the height of the rings may project from either side of the plane of concentric rings in order to represent the magnitude and/or sign of the data values for the rings.

The embodiment of FIGS. 5A and 5B also illustrates an example of how data may be displayed in an exploded view. This example is the result of displaying an exploded model of a three-dimensional graphical model with ordinal sections separated from each other, with empty space between them. The separation between ordinal values may enable a user to better visualize and access the individual ordinal sections for selection purposes. As described below, values may be selected for one or more reasons, such as to attach metadata to the values, to access metadata attached to the values or to modify the values. It should be appreciated that these examples show separation of ordinal values, but that the elements of a visualization may be separated in other ways. For example, the spacing between rings may be increased in some modes.

FIG. 6 is another view of a three-dimensional model demonstrating a rotated view of the model. The zoom level of the displayed image may be altered such that a user may view a portion of a three-dimensional model in detail. FIG. 7 is an image where the zoom level has been adjusted to view a portion of a model containing the central region with a column. The zoom level may also be adjusted to zoom out of view, allowing a user to return to a previous zoom level.

Any suitable component or components of a visualization system may perform the necessary functions to change the displayed image in response to user input. In the examples of FIGS. 5A, 5B, 6 and 7, the user input results in a different portion of the same three-dimensional model being displayed. In some embodiments, these commands may be implemented by graphics renderer 114. Though, it should be appreciated that any suitable component or components may respond to a command.

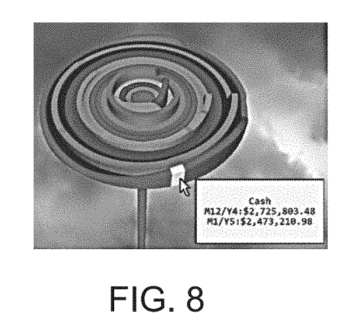

Details related to data values represented by the three-dimensional model may be presented along with the displayed image. A user may select a region and details such as the category and or data value(s) corresponding the region may be displayed. The details may be presented as text in the format of a text box that appears when a user selects the region. FIG. 8 is an example view of a three-dimensional model where a user selected a region of the outer ring and a text box containing information related to the data values for the region is displayed. A user may deactivate displaying of the details and/or select an additional region for displaying details.

The function illustrated in FIG, 8 may be implemented in any suitable way, such as by interaction of graphics renderer 114, model generator 112, and/or control module 110. As an example of a possible implementation, control module 110 may receive from an operating system of computing device 106 an indication of user input identifying a portion of the displayed image. Control module 110 may then interact with graphics renderer 114 to determine which portion of the three-dimensional model is displayed at that location. Control module 110 may then interact with model generator 112 to ascertain which portion of the data is depicted in that portion of the three-dimensional model. With this information, control module 110 may obtain data for display, which may be passed to graphics renderer 114 in connection with a command to overlay that data on the displayed image and to change the display characteristics of a portion of the displayed model to signal to a user that additional data about that portion is being displayed.

As an example of further functions that may be performed by a visualization system, presenting a visual representation may include displaying additional formats of the three-dimensional model, such as an unwrapped model and an expanded model. In some embodiments, a series of images illustrating the progression from one format to another may be displayed to a user. For progression from a plurality of rings model format to an unwrapped format, the series of images may illustrate a sequence of arranging the rings into a linear array. The series of images may be displayed as an animation. FIGS. 9A-B are images depicting intermediate steps of a progression sequence from a plurality of rings model format to an unwrapped model format. FIG. 9C is an image of the unwrapped model format. The unwrapped format may comprise a series of parallel linear arrays where each array corresponds to a dimension of the data values and the array is sized to represent a magnitude of the data values for the dimension. An array may correspond to a category of information where the data values corresponding to the category are arranged along the array. The data values may be ordered based on another category, acting as an ordinal, such as time. The magnitude of a data value may be represented as a height at a particular location of an array corresponding to the data value. A user may interact with the unwrapped model format in a similar manner as discussed above. For example, FIG. 9C illustrates selection of a region of the model by a user and display of details for the data values corresponding to the region. Additionally, a series of images progressing from an unwrapped format to a plurality of rings format may be depicted such as by reversing the sequence of images shown in FIGS. 9A-C.

The sequence of images may be generated in any suitable way. In some embodiments, model generator 112 may generate successive models from the data set, showing different amounts of “unwrap” of the spirals representing the data dimensions.

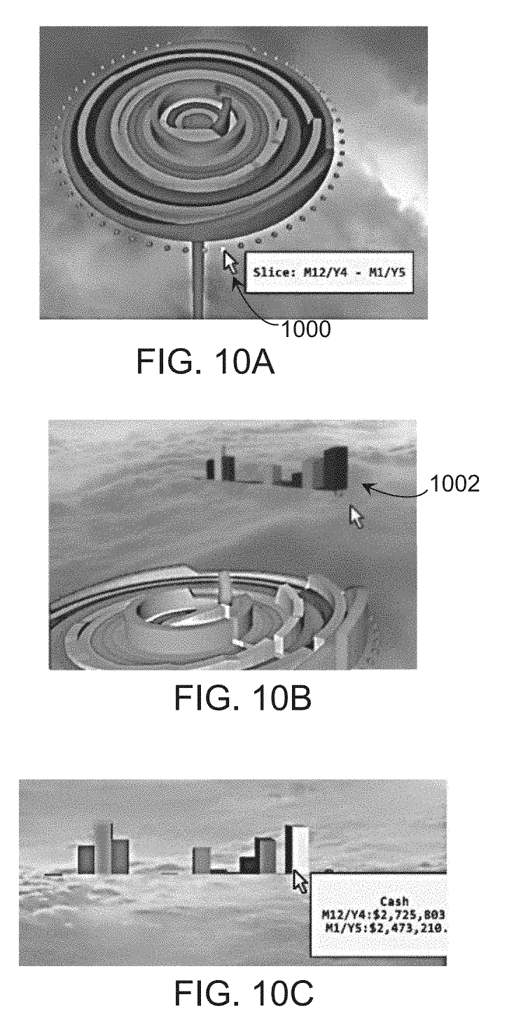

Another format for a visual representation of data values may include selecting a region of a plurality of rings and presenting a graphical representation of information represented by the region separate from the plurality of rings. In some embodiments, a slice of data values corresponding to multiple categories that share a same ordinal value, such as a time point or sequence number, may be selected and displayed separate from the plurality of rings. The data values in the slice may be represented as a bar graph. In response to a user selecting a region, a series of images depicting removing the slice from the model and displaying a representation of the data values in the slice separate from the model may be displayed. The series of images may be displayed as an animation sequence. In some embodiments, a user may select a portion of the displayed image that identifies a slice of data, such as region 1000 in FIG. 10A. Indicators, such as the circles in FIG. 10A, may lie around the concentric rings in the projected image and identify individual slices of data values corresponding to the same ordinal value, such as a time. Other types of indicators used to identify different slices may be presented in the displayed image with respect to the model. FIGS. 10A-C are a sequence of images illustrating slice 1002 of the model as the slice separates from the model. In the example shown in FIGS. 10A-C, the data values for the slice are represented as a bar graph 1002. In some embodiments, the sequence of images may portray the slice of the model raised vertically from the model and moved horizontally away from the model. Additionally, a series of images may be displayed indicating a slice returned to the model as an animation. In this manner, a user may extract portions of a model to view details regarding the data of the model.

Any suitable type of information may be visualized in accordance with the techniques of the present application. In some embodiments, financial data may be represented in a three-dimensional model having a plurality of rings where the same time is represented at common angular locations around the rings. Any suitable unit of time (e.g., month) and/or number of divisions may be used to represent the data and any amount of time may be represented around a ring. A “zero disk” separating positive from negative numbers on a central column may designate a zero value. The plurality of rings may represent various categories of financial information (e.g., assets). For example, a ring may represent cash assets where assets may be represented above the zero disk while equity and liability may be represented below the zero disk. One or more central columns may represent other aspects of the financial information. For example, incoming revenue may be shown as a central column above the rings while expenses and taxes are portrayed below the rings.

Other types of information may be visualized in accordance with the techniques described herein such as engineering data, education data, labor market data, legal data, sports data, medical data, genetic data, nanotechnology data, biotechnology data, chemistry data, nutrition data, assessment data, scientific data, manufacturing data, economics data, statistics data, demographics data, tax data, business data, performance data, quality assurance data, rule based expert system data, fuzzy logic data, and neural-network data.

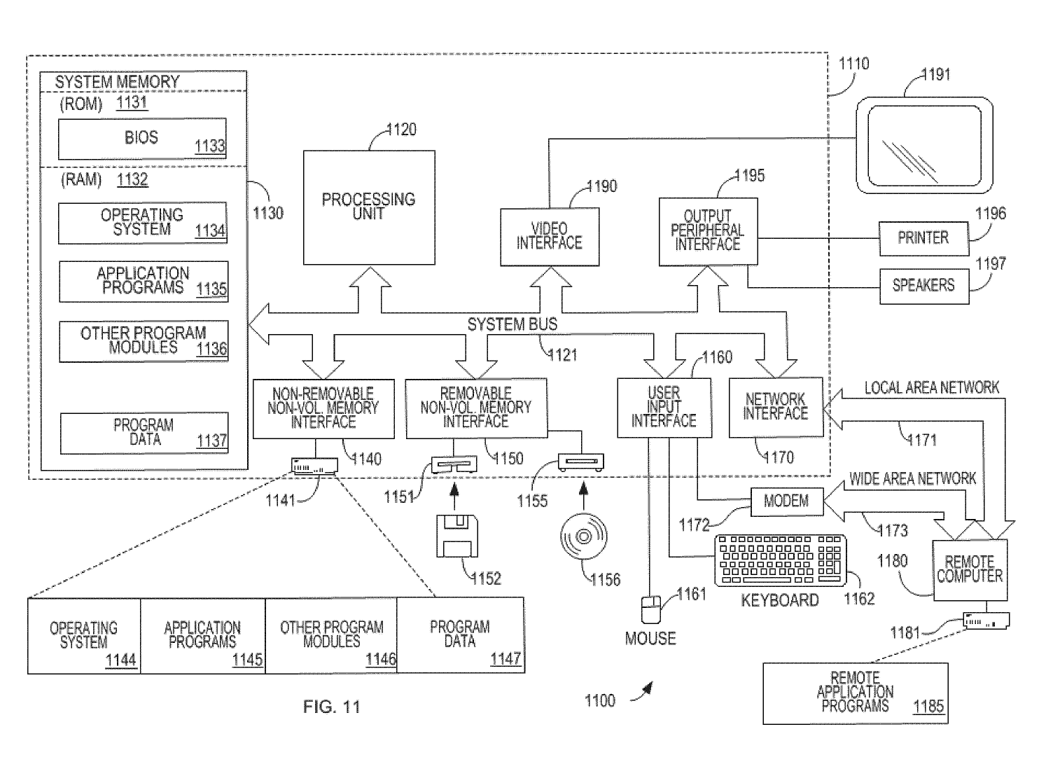

In some embodiments, a visualization system may be implemented by programming in a computing system environment. That environment may include suitable user input/output devices as well as processing capabilities to implement the functions as described herein. An illustrative implementation of a computer system environment 1100 that may be used in connection with some embodiments is shown in FIG. 11. One or more computer systems may be used to implement any of the functionality described above. It should be appreciated that, though FIG. 11 shows components of a conventional computer system, embodiments of a data processing system may be implemented in or using a tablet, smartphone or other computing device that may not have all of the components illustrated in FIG. 11 or may have different forms of user input, storage or other components not illustrated in FIG. 11.

A computer system may include one or more processors and one or more computer-readable storage media (i.e., tangible, non-transitory computer-readable media), e.g., volatile storage and one or more non-volatile storage media, which may be formed of any suitable non-volatile data storage media. The processor may control writing data to and reading data from the volatile storage and/or the non-volatile storage device in any suitable manner, as aspects of the present application are not limited in this respect. To perform any of the functionality described herein, processor may execute one or more instructions stored in one or more computer-readable storage media (e.g., volatile storage and/or non-volatile storage), which may serve as tangible, non-transitory computer-readable media storing instructions for execution by the processor.

The computing system environment 1100 is only one example of a suitable computing environment and is not intended to suggest any limitation as to the scope of use or functionality of the invention. Neither should the computing environment 1100 be interpreted as having any dependency or requirement relating to any one or combination of components illustrated in the exemplary operating environment 1100.

The invention is operational with numerous other general purpose or special purpose computing system environments or configurations. Examples of well known computing systems, environments, and/or configurations that may be suitable for use with the invention include, but are not limited to, personal computers, server computers, mobile or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 11, an exemplary system for implementing the invention includes a general purpose computing device in the term of a computer 1110. Components of computer 1110 may include, but are not limited to, a processing unit 1120, a system memory 1130, and a system bus 1121 that couples various system components including the system memory to the processing unit 1120. The system bus 1121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 1110 typically includes a variety of computer readable media. Computer readable media can be any available media that can be accessed by computer 1110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 1110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 1130 includes computer storage media in the form of volatile and/or nonvolatile memory such as read only memory (ROM) 1131 and random access memory (RAM) 1132. A basic input/output system 1133 (BIOS), containing the basic routines that help to transfer information between elements within computer 1110, such as during start-up, is typically stored in ROM 1131. RAM 1132 typically contains data and/or program modules that are immediately accessible to and/or presently being operated on by processing unit 1120. By way of example, and not limitation, FIG. 11 illustrates operating system 1134, application programs 1135, other program modules 1136, and program data 1137.

The computer 1110 may also include other removable/non-removable, volatile/nonvolatile computer storage media. By way of example only, FIG. 11 illustrates a hard disk drive 1141 that reads from or writes to non-removable, nonvolatile magnetic media, a magnetic disk drive 1151 that reads from or writes to a removable, nonvolatile magnetic disk 1152, and an optical disk drive 1155 that reads from or writes to a removable, nonvolatile optical disk 1156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1141 is typically connected to the system bus 1121 through an non-removable memory interface such as interface 1140, and magnetic disk drive 1151 and optical disk drive 1155 are typically connected to the system bus 1121 by a removable memory interface, such as interface 1150.

The drives and their associated computer storage media discussed above and illustrated in FIG. 11, provide storage of computer readable instructions, data structures, program modules and other data for the computer 1110. In FIG. 11, for example, hard disk drive 1141 is illustrated as storing operating system 1144, application programs 1145, other program modules 1146, and program data 1147. Note that these components can either be the same as or different from operating system 1134, application programs 1135, other program modules 1136, and program data 1137. Operating system 1144, application programs 1145, other program modules 1146, and program data 1147 are given different numbers here to illustrate that, at a minimum, they are different copies. A user may enter commands and information into the computer 1110 through input devices such as a keyboard 1162 and pointing device 1161, commonly referred to as a mouse, trackball or touch pad. Other input devices (not shown) may include a microphone, joystick, game pad, satellite dish, scanner, or the like. These and other input devices are often connected to the processing unit 1120 through a user input interface 1160 that is coupled to the system bus, but may be connected by other interface and bus structures, such as a parallel port, game port or a universal serial bus (USB). A monitor 1191 or other type of display device is also connected to the system bus 1121 via an interface, such as a video interface 1190. In addition to the monitor, computers may also include other peripheral output devices such as speakers 1197 and printer 1196, which may be connected through a output peripheral interface 1195.

The computer 1110 may operate in a networked environment using logical connections to one or more remote computers, such as a remote computer 1180. The remote computer 1180 may be a personal computer, a server, a router, a network PC, a peer device or other common network node, and typically includes many or all of the elements described above relative to the computer 1110, although only a memory storage device 1181 has been illustrated in FIG. 11. The logical connections depicted in FIG. 11 include a local area network (LAN) 1171 and a wide area network (WAN) 1173, but may also include other networks. Such networking environments are commonplace in offices, enterprise-wide computer networks, intranets and the Internet.

When used in a LAN networking environment, the computer 1110 is connected to the LAN 1171 through a network interface or adapter 1170. When used in a WAN networking environment, the computer 1110 typically includes a modem 1172 or other means for establishing communications over the WAN 1173, such as the Internet. The modem 1172, which may be internal or external, may be connected to the system bus 1121 via the user input interface 1160, or other appropriate mechanism. In a networked environment, program modules depicted relative to the computer 1110, or portions thereof, may be stored in the remote memory storage device. By way of example, and not limitation, FIG. 11 illustrates remote application programs 1185 as residing on memory device 1181. It will be appreciated that the network connections shown are exemplary and other means of establishing a communications link between the computers may be used. A data visualization system in accordance with the techniques described herein may take any suitable form, as aspects of the present invention are not limited in this respect.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of embodiments of the present invention comprises at least one computer-readable storage medium (i.e., at least one tangible, non-transitory computer-readable medium, e.g., a computer memory (e.g., hard drive, flash memory, processor working memory, etc.), a floppy disk, an optical disc, a magnetic tape, or other tangible, non-transitory computer-readable medium) encoded with a computer program (i.e., a plurality of instructions), which, when executed on one or more processors, performs above-discussed functions of embodiments of the present invention. The computer-readable storage medium can be transportable such that the program stored thereon can be loaded onto any computer resource to implement aspects of the present invention discussed herein. In addition, it should be appreciated that the reference to a computer program which, when executed, performs above-discussed functions, is not limited to an application program running on a host computer. Rather, the term “computer program” is used herein in a generic sense to reference any type of computer code (e.g., software or microcode) that can be employed to program one or more processors to implement above-discussed aspects of the present invention.

The phraseology and terminology used herein is for the purpose of description and should not be regarded as limiting. The use of “including,” “comprising,” “having,” “containing”, “involving”, and variations thereof, is meant to encompass the items listed thereafter and additional items. Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements from each other.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A method of operating a computing system to produce visual representations of data, the data expressing relational information organized in a plurality of dimensions, wherein data associated with dimensions of the plurality of dimensions has a plurality of ordered values, and the method comprising:
generating, using a graphics rendering component implemented via at least one processor, a three-dimensional graphical model having a plurality of concentric rings corresponding to the plurality of dimensions, wherein a ring of the plurality of concentric rings is sized to represent ordering and magnitude of the ordered values of the corresponding dimension; and
displaying an image illustrating a first view of the three-dimensional graphical model on a display.

2. The method of claim 1, wherein:
the plurality of concentric rings are centered on a central region,
the three-dimensional model includes a column positioned perpendicular to the plurality of concentric at the central region, and
the column represents aggregated values from at least one dimension of the plurality of dimensions.

3. The method of claim 1, the method further comprising:
generating an unwrapped model of the three-dimensional graphical model where each ring of the plurality of concentric rings is represented linearly;
in response to a user input, displaying on a display an image of the unwrapped model illustrating a view of the unwrapped model in a three-dimensional environment.

4. The method of claim 1, the method further comprising:
in response to user input, presenting on the display a graphical representation of information represented by a portion of the three-dimensional graphical model separate from the displayed image.

5. The method of claim 1, the method further comprising:
in response to a user input, presenting, on the display, further information related to information represented by a portion of the three-dimensional graphical model, the further information indicating selection of a region of the image corresponding to the portion.

6. The method of claim 1, the method further comprising:
modifying a value of the data;
updating the three-dimensional graphical model to reflect the modified value; and
displaying the updated three-dimensional graphical model.

7. The method of claim 1, wherein the displayed image illustrates the first view of the three-dimensional graphical model in a three-dimensional environment.

8. The method of claim 7, the method further comprising:
modifying, in response to a user input, the displayed image to illustrate a second view of the three-dimensional graphical model in the three-dimensional environment, wherein a transition from the first to second view of the three-dimensional graphical model is presented on the display in a moving real-time transition that responds to real-time interactive user controls.

9. The method of claim 8, wherein the second view is a rotated view of the three-dimensional graphical model by an angle from the first view.

10. The method of claim 8, wherein the first view and the second view have different zoom levels.

11. The method of claim 1, wherein the ordering of the ordered values is represented in the three-dimensional graphical model by bars in a spiral on the ring.

12. The method of claim 11, wherein the ordering of the ordered values relates to time information corresponding to the ordered values.

13. The method of claim 1, the method further comprising:
displaying an exploded model of the three-dimensional graphical model where ordinal sections are separated from each other with empty space between them.

14. An apparatus comprising:
a display; and
control circuitry configured to perform a method comprising:
receiving data expressing relational information organized in a plurality of dimensions, wherein data associated with dimensions of the plurality of dimensions has a plurality of ordered values, and the method comprising:
generating a three-dimensional graphical model having a plurality of concentric rings corresponding to the plurality of dimensions, wherein a ring of the plurality of concentric rings is sized to represent ordering and magnitude of the ordered values of the corresponding dimension; and
displaying an image illustrating a first view of the three-dimensional graphical model on the display.

15. At least one computer-readable storage medium storing computer-executable instructions that, when executed, perform a method of producing visual representations of data, the data expressing relational information organized in a plurality of dimensions, wherein data associated with dimensions of the plurality of dimensions has a plurality of ordered values, and the method comprising:
generating, using a graphics rendering component implemented via at least one processor, a three-dimensional graphical model having a plurality of concentric rings corresponding to the plurality of dimensions, wherein a ring of the plurality of concentric rings is sized to represent ordering and magnitude of the ordered values of the corresponding dimension; and
outputting information related to an image illustrating a first view of the three-dimensional graphical model.
